(19) United States
(12) Patent Application Publication
(10) Pub. No.: US 2016/0339371 A1
(43) Pub. Date: Nov. 24, 2016

(54) FLUID FILTER

(71) Applicant: ICON TECHNOLOGY SYSTEMS LIMITED, Altrincham Cheshire (GB)

(72) Inventor: David CUPIT, Altrincham, Cheshire (GB)

(21) Appl. No.: 15/111,794

(22) PCT Filed: Jan. 15, 2015
(86) PCT No.: PCT/GB2015/050077

§ 371 Date: Jul. 14, 2016

(30) Foreign Application Priority Data
Jan. 16, 2014 (GB) 1400747.0

(51) Int. Cl. B01D 35/147; C02F 1/00; B01D 29/56; B01D 29/15; C02F 1/28; C02F 1/42; B01D 41/04; B01D 24/00

(52) U.S. Cl. CPC B01D 35/147; B01D 41/04; C02F 1/006; B01D 24/008; B01D 29/15; C02F 1/003; C02F 1/283; C02F 1/42; B01D 29/56; B01D 2201/08; B01D 2201/34; C02F 2001/425; C02F 2103/026

(57) ABSTRACT

A filter insert for filtering a fluid, comprising: an elongate closed-ended tube including a circumferential sealing rim; and a conduit for conveying fluid, one end of the conduit forming an inlet opening, the other end of the conduit being suitable for dispersing fluid into a filter medium located within the tube.

The present invention relates to filters, and in particular, but without limitation to, canister-type, in-line filters. The invention is particularly applicable to the field of water, and potable water, filtration.

Filters, and in particular, water filters, are widely used in domestic and commercial settings to filter out impurities in fluids, such as potable water, body fluids, e.g. blood, chemicals and/or water used in high-cleanliness applications e.g. medical applications.

Where water is to be used in beverage machines other aspects of the water quality become important.

The quality of the feed water is important due to the potential for conduits and the machinery involved to suffer from ‘scaling’.

Scaling is the term used to describe deposits of limescale, the hard, off-white, chalky deposit found in kettles, hot-water boilers and the inside of inadequately maintained hot-water central heating systems. Limescale is difficult to remove and can be extremely detrimental to the operation of machinery and conduits used in beverage preparation and may even cause permanent damage.

Scaling is often found deposited on the heating elements of water heaters and principally comprises calcium carbonate. Feed water is often described as ‘hard’ or ‘soft’ and this is generally a term to describe the mineral content of the feed water: hard water having a higher mineral content than soft water.

Heating water increases the concentration of dissolved carbonate which reacts with dissolved calcium to form calcium carbonate precipitate which forms the limescale found on heating elements and conduits of water.

Other constituents of typical feed water might include organic compounds, chlorine and the like and these can affect its taste. Therefore, a simple method for in-situ removal of microbiological contamination, bicarbonate hardness, volatile organic compounds, as well as chlorine and the like, is important for meeting certain consumer concerns, raising the quality of drinking water in some locations, improving the taste of beverages, and protecting machinery from the adverse effects of limescale.

Depending on how much fluid or water is needed, and/or whether the fluid or water is supplied from a mains supply or a tank, the fluid can either be filtered batch-wise, or continuously.

In situations where a large volume of fluid needs to be filtered, or where the fluid flow rate is relatively high, it is often more convenient to use a plumbed-in, continuous filtration system. Such systems are relatively well-known and generally comprise a filtration vessel comprising an inlet aperture connected to the supply of fluid and an outlet aperture connected to a tap or device using the filtered fluid. Contained within the filtration vessel, a filter medium is generally provided that is sealingly interposed between the inlet aperture and outlet aperture in a manner that only allows fluid to flow out through the outlet aperture once it has passed through the filtration medium.

Various filtration media can be used depending on the size and chemistry of the impurities that need to be removed from the fluid/water supply. In fact, the filter system may comprise a series of filters that successively filter out different sizes and/or types of impurities. Such, so-called multi-stage filters can be contained in a single unit, or a series of filters can be used sequentially in a given fluid/water supply.

Known filtration media include resins, scrims, reticulated sheets, porous membranes and indeed porous block media, such as compressed activated carbon blocks.

In use, filters need to be replaced periodically once the filter medium has become clogged with filtered-out impurities, or where there is a risk of biological growth over extended periods of time. For the sake of convenience, and to reduce the likelihood of incorrect servicing, it has become customary for the filter vessel and filter medium to be formed as a single disposable filter cartridge that can be clipped into and out of the supply. Such known cartridges generally comprise proprietary connectors that prevent, or reduce the likelihood of, incorrect installation thereby reducing the likelihood of contaminating the fluid or water supply, e.g. by fitting a filter with the inlet and outlet apertures reversed.

A major drawback of known disposable filter cartridges is the fact that they are comprised of various materials, e.g. a plastics vessel, rubber seals, a carbon block etc., which can make recycling of the cartridges at the end of their useful life difficult and costly. It has been proposed to replace only the filter medium, rather than the entire canister, to alleviate this problem but this solution has not been well-received owing to the fact that the remaining parts of the filter cartridge need to be thoroughly cleaned and reassembled before they can be put back into service. Moreover, a factory-sealed unit, rather than one that requires end-user intervention, is generally considered to be less susceptible to incorrect assembly, and can be monitored and/or checked at each stage of the manufacture, transport, installation and disposal cycle.

It is an object of the present invention to address one or more of the above problems and to provide an alternative and/or improved fluid/water filter system.

The present invention is as described herein and in the claims.

From a first aspect the present invention provides a filter insert for filtering a fluid, comprising:
an elongate closed-ended tube including a circumferential sealing rim; and
a conduit for conveying fluid, one end of the conduit forming an inlet opening, the other end of the conduit being suitable for dispersing fluid into a filter medium located within the tube.

The filter insert may further comprise at least one filter chamber containing a second filter medium, the at least one filter chamber being interposed between the filter medium contained within the tube and an outlet opening for removal of the filtered fluid.

The insert may be thin-walled and optionally flexible because rigidity and strength are provided by the outer holding assembly. The product is effective even at larger sizes suitable for use in the food services industry for example. The product brings significant benefits in terms of recyclability and environmental considerations. The device may be reused and refilled as necessary. Furthermore considerable flexibility is provided due to the possibility of using different types of filter media and optionally a plurality of filter media.

Flow through the filter medium from bottom to top further enhances the efficacy.

It will be obvious to those skilled in the art that variations of the present invention are possible and it is intended that the present invention may be used other than as specifically described herein.

Specific non-limiting embodiments of the invention will now be described by way of example only and with reference to the accompany drawings, in which:

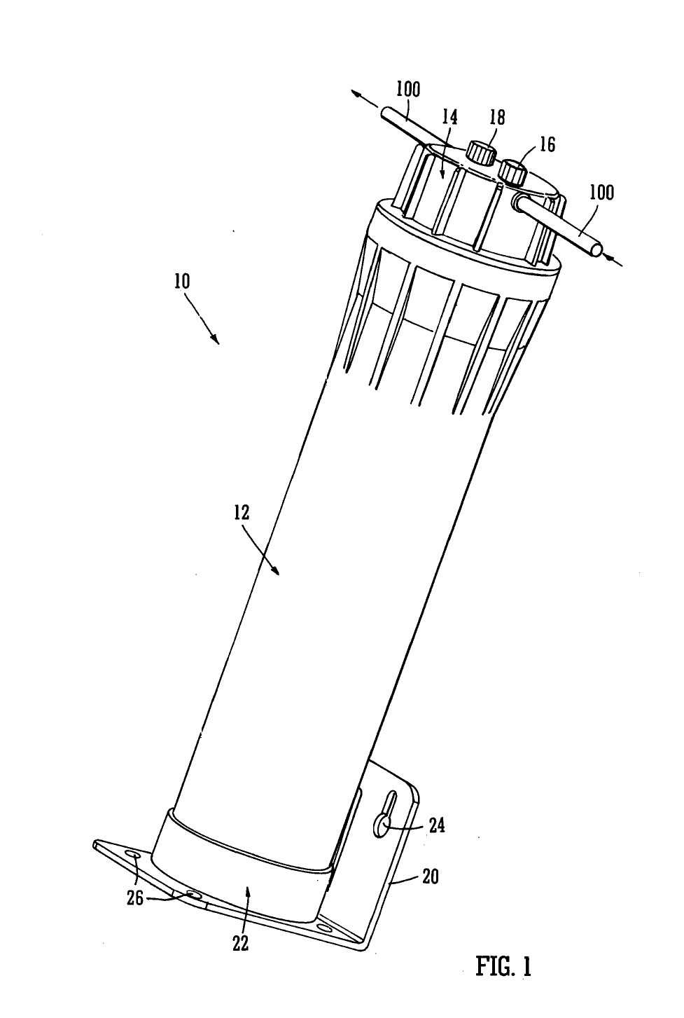

FIG. 1 is a side perspective view of a filter according to the present invention;

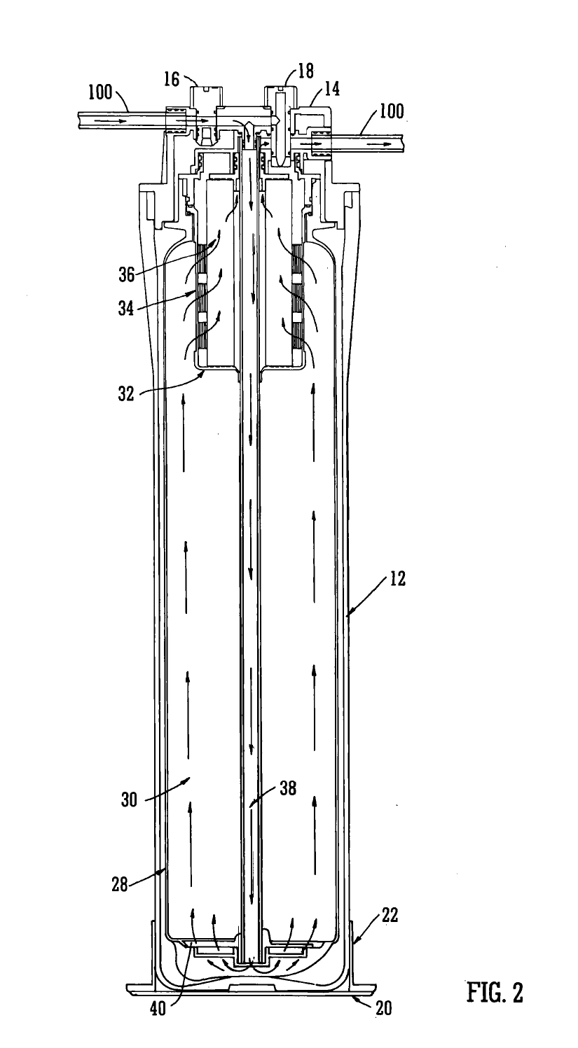

FIG. 2 is a cross-sectional view through the filter of FIG. 1;

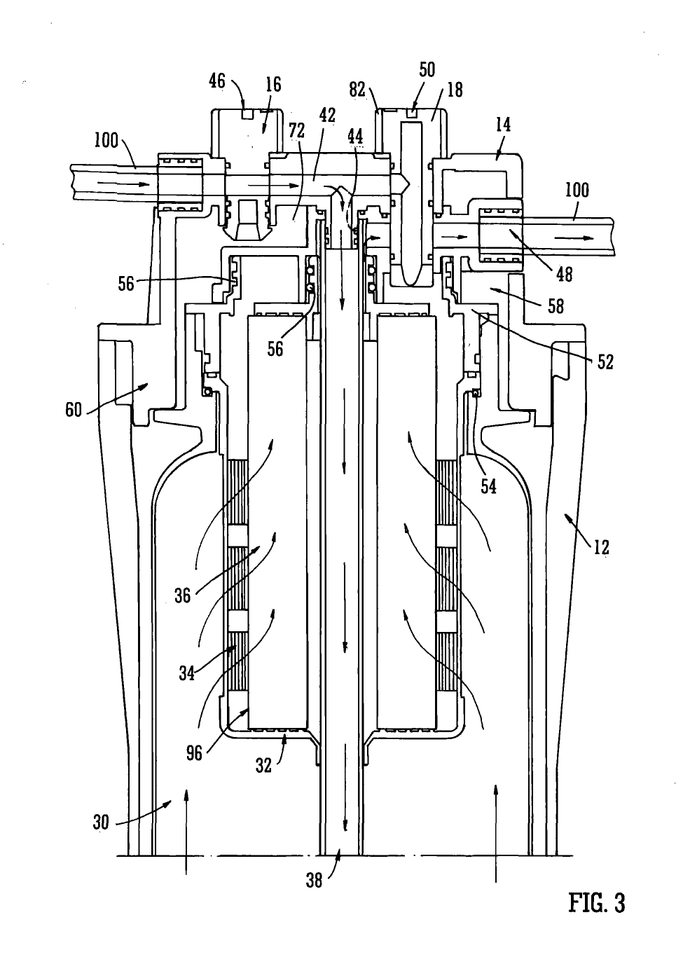

FIG. 3 is a close-up, cross-sectional view of the upper portion of the filter of FIG. 1;

FIG. 4 is a perspective view from above of the connection head of the filter according to the present invention;

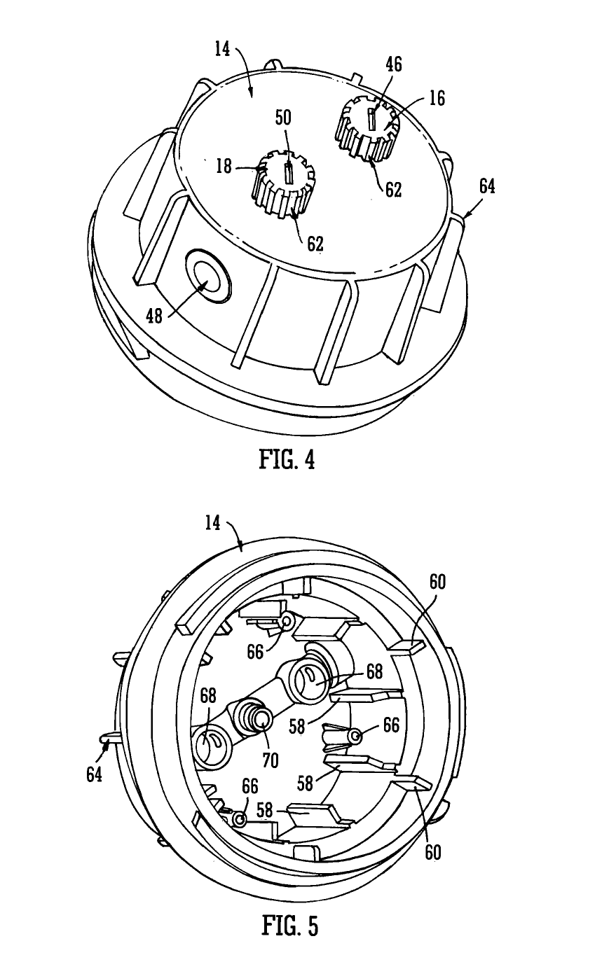

FIG. 5 shows a perspective view from below of the connection head of the filter according to the present invention;

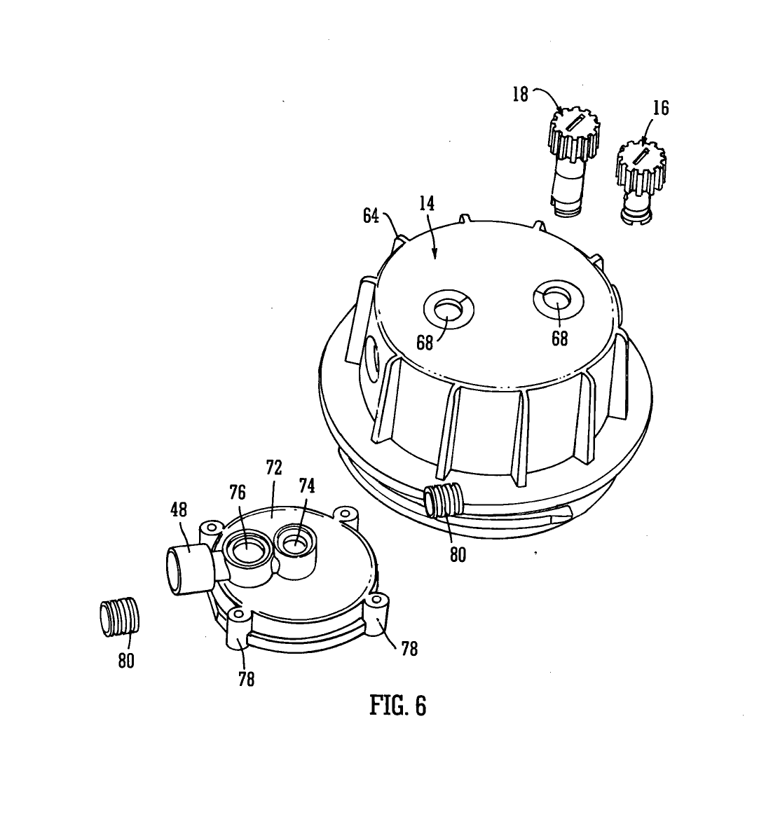

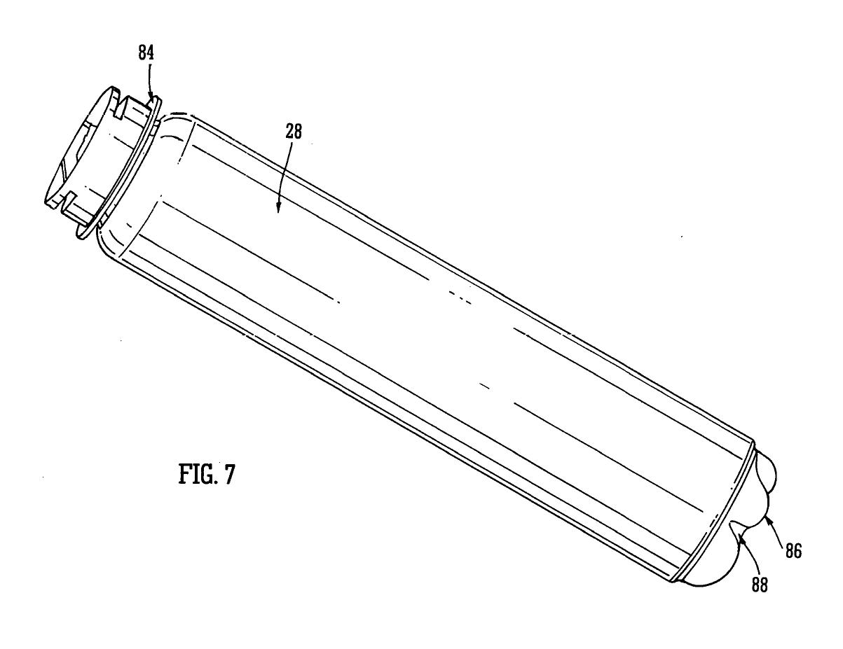

FIG. 6 is an exploded, perspective view of the connection head shown in FIGS. 4 and 5 showing how the manifold and control valves are configured;

FIG. 7 is a perspective view of a filter insert according to the present invention;

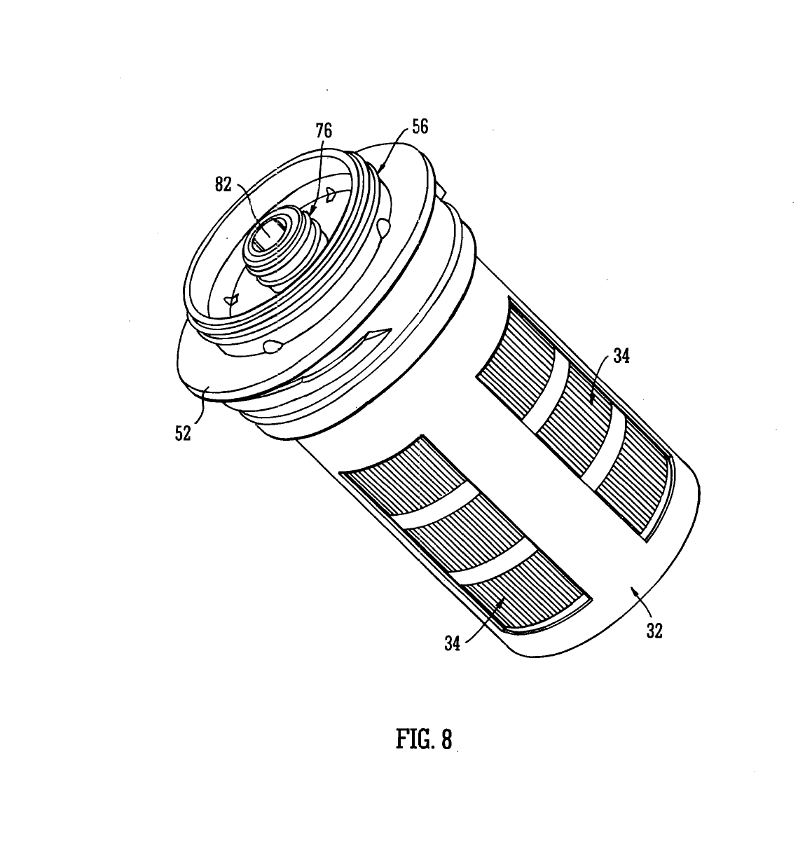

FIG. 8 is a perspective view of a filter canister suitable for retention within the filter insert of FIG. 7;

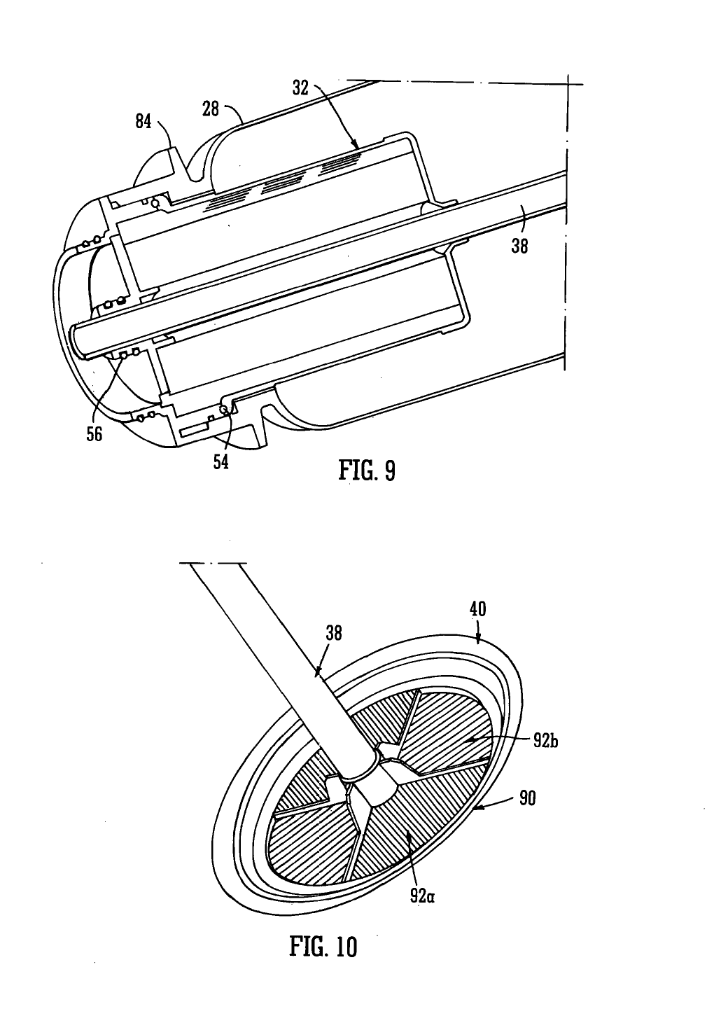

FIG. 9 is an exploded, cross-sectional view through the filter insert having the filter canister retained therein;

FIG. 10 is a perspective view of the spreader that dispenses fluid into the filter according to the present invention;

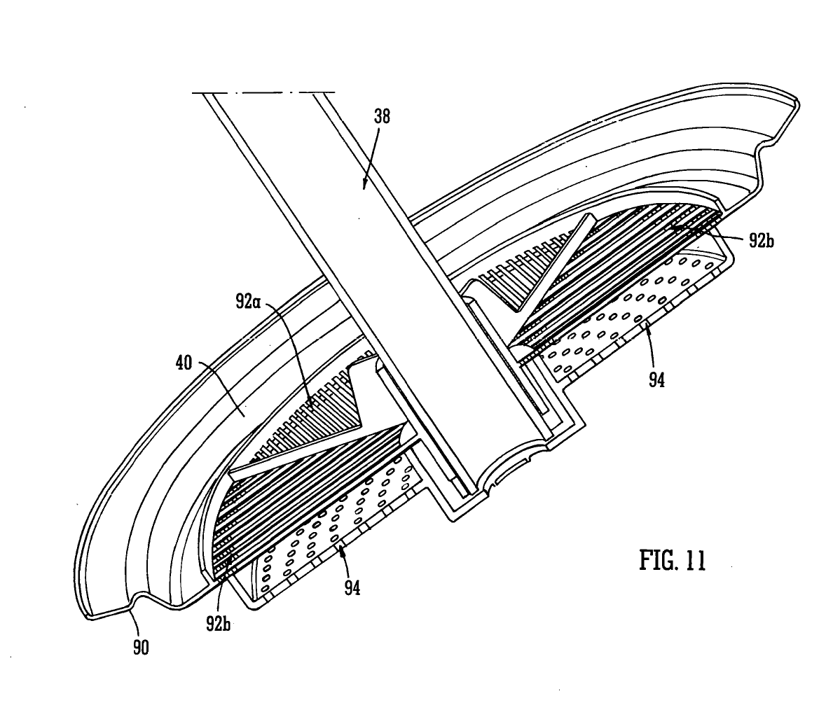

FIG. 11 is an exploded, cross-sectional view through the spreader of FIG. 10;

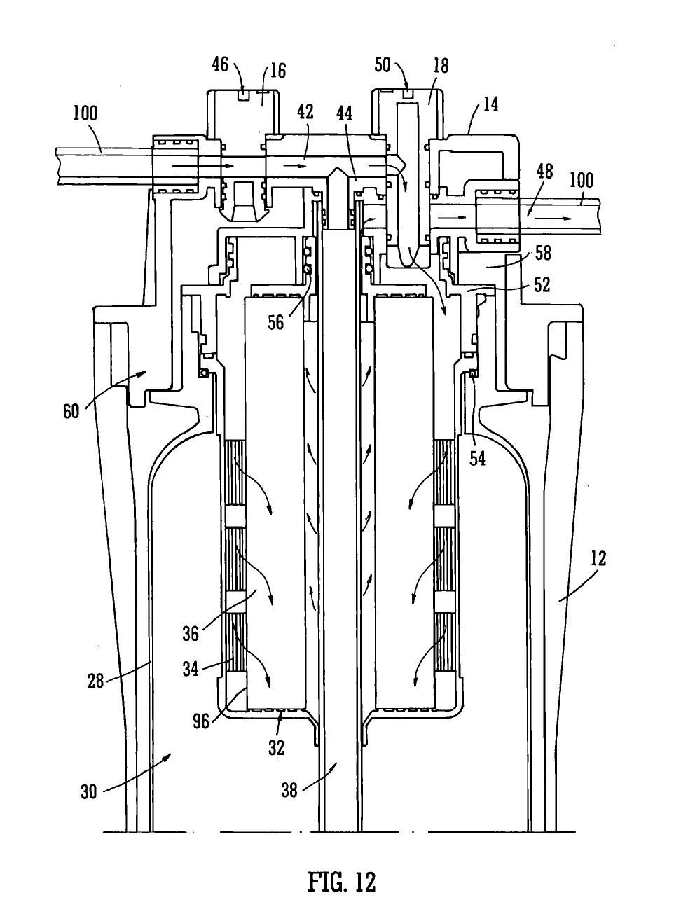

FIG. 12 is a close-up, cross-sectional view of the upper portion of the filter of FIG. 1 showing the operation of the filter when the bypass valve is opened;

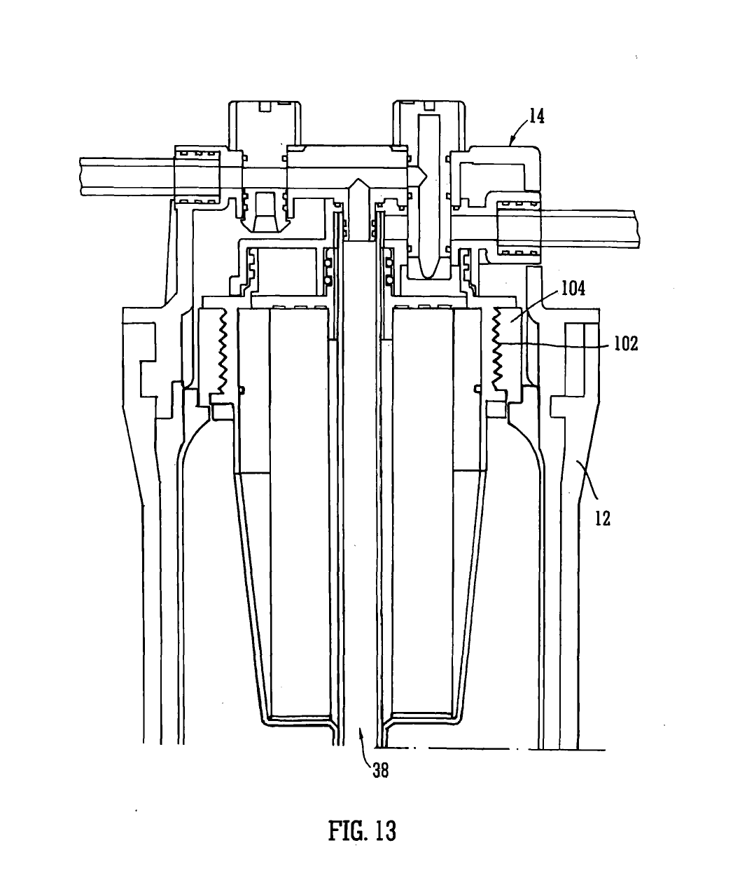

FIG. 13 is a close-up, cross-sectional view of the upper portion of a filter according to a further embodiment of the present invention; and

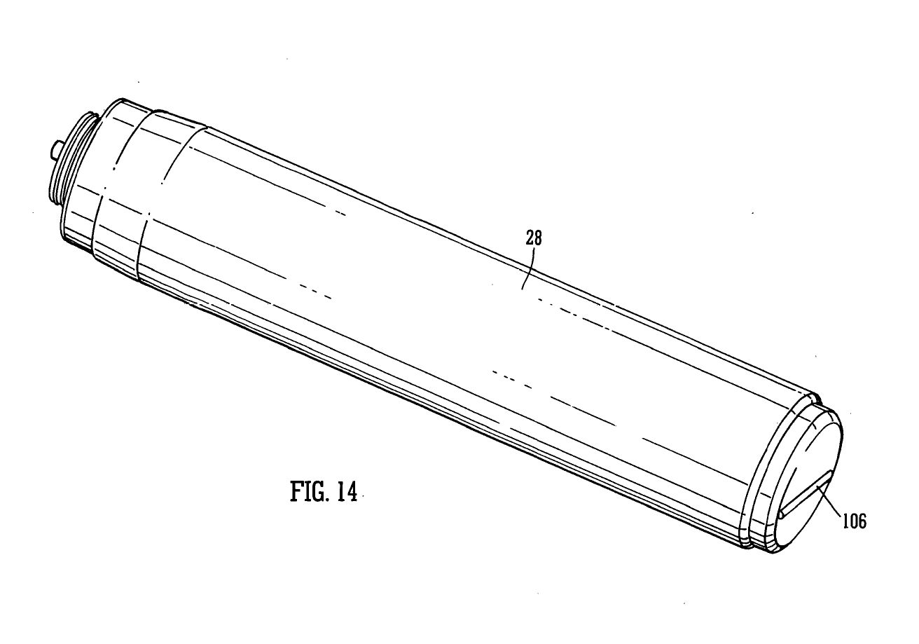

FIG. 14 is a perspective view of a filter insert according to a further embodiment of the present invention.

Referring now to the drawings, a filter 10 for removing impurities from a fluid supply according to the present invention is shown in FIG. 1. The filter 10 depicted in FIG. 1 is particularly suitable to the field of water, and potable water, filtration, although the skilled person will appreciate that such filter 10 finds application in many other fields.

As shown in FIG. 1, the filter 10 comprises a generally elongate, rigid filter housing 12 which contains filter media. The upper end of the filter housing 12 is sealingly affixed around the periphery of a connection head 14. The connection head 14 contains two apertures which extend radially outward on opposing sides of the connection head 14. In use, the apertures are connected to pipework 100. The connection head 14 includes an inlet aperture for connection to a fluid supply (not shown) and outlet aperture connected to an outlet tap or device (not shown) using the filtered fluid. As shown in FIG. 1, fluid flows from the fluid supply along pipework 100 to the connection head 14. The fluid is then passed into interior of the filter housing 12 which contains one or more types of filter media. At a general level, the one or more types of filter media are sealingly interposed between the inlet and outlet apertures so that the fluid must pass through the one or more types of filter media in a controlled manner, and thus be filtered as it flows from the fluid supply to the outlet tap or device. This is indicated by the flow arrows in FIG. 1.

The skilled person will appreciate that the filter 10 can be supplied having a number of different capacities, and which are primarily dependent upon the length of the filter housing 12. In one embodiment, the length of the filter housing is approximately 300 to 400 mm, e.g. approximately 310 mm. In another embodiment, the length of the filter housing is approximately 400 to 600 mm, e.g. approximately 515 mm.

Extending axially outward from the upper surface of the connection head 14 are two rotary valves. As shown in FIG. 1, a shut-off or isolation valve 16 is positioned on the connection head 14 that can be rotated to control the fluid supply to the filter 10 either on or off. There is also a bypass valve 18 which is used to selectively control the effective fluid flow path within the filter 10 such that it is possible to selectively control the fluid flow path through one or more types of filter media.

FIG. 1 also shows how the filter 10 can be secured to a wall or other mounting surface using a mounting clip 20. The clip 20 generally comprises an L-shaped body portion with one panel defining an aperture 22 into which the bottom of the filter housing 12 can be retained in an interference fit. The clip 20 can be secured to a generally vertical mounting surface using screws (not shown) through slotted apertures 24, or downwards to a generally horizontal mounting surface through apertures 26. Alternatively, the mounting clip 20 may be configured as a generally flat panel defining an opening or collar for receiving and retaining the filter housing 12. The skilled person will appreciate that the clip 20 can also be secured to a mounting surface using suitable adhesive and/or self-adhesive strips, or any other suitable fixing means.

In a preferred embodiment, the housing 12, connection head 14 and mounting clip 20 are formed from die cast aluminium or are injection moulded from a suitable plastics material. The advantages of using die cast aluminium are in terms of weight and the high dimensional stability and good mechanical properties exhibited for thin walled designs. The outer sections of the housing 12, connection head 14 and mounting clip 20 can also be coated, preferably using a powder coating process.

Further detail on the operation of the filter 10 is shown in FIG. 2, which is a cross-sectional view through the filter 10. As can be seen, the connection between the upper end of the filter housing 12 around the periphery of the connection head 14 also retains a filter insert 28 which is slidingly receivable within the housing 12. The filter insert 28 defines a fluid impermeable barrier surrounding a filter medium 30 that is retained inside the housing 12 in the flow path between the inlet and outlet apertures. The fluid impermeable filter insert 28 being arranged to prevent the fluid from coming into contact with the housing 12.

FIG. 2 shows that the filter insert 28 also retains a second filter stage or element which is shown as filter canister 32 containing a second filter medium 36. The filter canister 32 being slidingly receivable within the filter insert 28. In an alternative embodiment of the invention, as shown in FIG. 13, the filter canister 32 is retained inside the filter insert 28 by way of an external circumferential screw thread 100 on the filter canister 32. This meets with an internal screw thread 102 defined in an inner acetyl plastic moulded ring 104 which is insert-moulded inside the opening of the filter insert 28. This ensures a strong watertight joint between the filter insert 28 and filter canister 32, which is capable of sustaining the pressure required within the housing 12.

In a preferred embodiment, the first filter medium 30 inside the filter insert 28 includes resins, scrims, reticulated sheets, porous membranes and small resin beads that are used primarily for de-calcifying water. The second filtration stage is achieved using filter canister 32 containing a second filter medium 36. In a preferred embodiment, the filter canister 32 is used to de-chlorinate water using an activated carbon block 36. The water is able to flow through a series of apertures or slats 34 in the filter canister 32. To retain the carbon in place safely inside the filter canister 32, the carbon is retained within a non-woven mesh to allow high flow rates but avoids any blockage by the resin beads.

The filter insert 28 and filter canister 32 are dimensioned to fit inside one another. The filter canister 32 is generally annular in shape so that a feed tube 38, which is connected to the inlet aperture, supplies water to the bottom of the filter insert 28 via a spreader 40. More detail on the spreader 40 is shown in FIGS. 10 and 11. The function of the spreader 40 is to supply water to the bottom of the filtration medium 30. The shape of the spreader 40 serves two main purposes, firstly to ensure that water is dispensed evenly around the cross-section of filter medium 30. Secondly, the spreader 40 is configured to create turbulence through the beads of the filtration medium 30 which allows a higher surface contact and therefore increases performance and capacity.

The flow path through the device is indicated using the flow arrows in FIG. 2 when the filter 10 is used in a substantially vertical configuration. As can been seen, supplying water from the spreader 40 inside the generally elongate fluid impermeable filter insert 28 ensures that the water follows a continuous filtration path, firstly through the filter medium 30, and then through the second filtration stage defined by filter medium 36 contained in filter canister 32. This is described in more detail with respect to FIG. 3.

The filter insert 28 may be formed from a flexible plastics material which can be blow-moulded high-density polyethylene HPPE or polyethylene terephthalate PET. The wall thickness of the filter insert 28 can vary depending on the material used. In some embodiments it can be around 1.5 to 2.3 mm. In other embodiments it can be around 0.5 to 1 mm. It can be thinner; for example a laminate, e.g. a four layer laminate, may be used, which has a thickness of less than 0.5 mm, e.g. around 0.1 to 0.3 mm, e.g. approximately 0.16 to 0.2, e.g. approximately 0.18 mm.

The filter insert material does not need to be thick because the surrounding structure or housing imparts the necessary strength and rigidity.

FIG. 3 is an exploded, cross-sectional view of the upper portion of the filter 10 of FIG. 1 and shows further detail of the construction of the connection head 14 and the housing 12. As again shown by the flow arrows, water generally enters the housing 12 via pipework 100. If the shut-off or isolation valve 16 is open, water flows through an inlet channel 42 formed in a manifold 72 which is an integral part of the connection head 14. The inlet channel 42 is formed from a stainless steel tube which is insert cast in the manifold 72. The water flows down the feed tube 38 to the spreader 40 located at the bottom of the filter insert 28. The spreader 40 is not shown in FIG. 3. An ‘O’ ring seal 44 is used to provide a watertight connection between the inlet channel 42 and the feed tube 38.

The water then percolates up through the filter medium 30 and is able to then enter the second stage of the filtration path through openings 34 in filter canister 32. The second stage of the filtration is achieved in a preferred embodiment, using carbon block is used to de-chlorinate the water. The filtered water then flows inwardly towards the feed tube 38 and exits the connection head 14 via a space defined between the feed tube 38 and a central opening 82 in the filter canister 32. The filtered water flows out of an outlet channel 48 which is connected to a tap or device (not shown) through pipework 100. Isolation valve 16 and bypass valve 18 include slotted apertures 46 and 50, respectively, so that the flows can be controlled using, for example, a screwdriver.

To ensure watertight construction ‘O’ ring seals 44 are provided between inlet channel 42 and the feed tube 38. An ‘O’ ring seal 54 is also provided between the filter insert 28 and the filter canister 32. Equally, the connection between the top of the filter canister 32 and the connection head 14 is sealed using inner and outer ‘O’ ring seals 56.

The connection head 14 is designed to twist off the housing 12 in a release mechanism using a three radial ramp and snatch. The physical connection between the head 14 and the housing 12 also ensures that a series of pressure locking ribs 58 and 60 retain the canister 32 and the filter insert 28, respectively. Further detail of this is shown in FIG. 5.

FIGS. 4 to 6 show further detail on the connection head 14 that is used to connect the filter 10 to a water supply (not shown) and outlet aperture connected to an outlet tap or device (not shown) using the filtered water. The head 14 also includes at regular positions around its periphery support ribs 64 which prevent any high pressure damage or deformation to the head 14 and aid the user when tightening or releasing the head 14 from the housing 12. As shown in FIG. 4, the isolation valve 16 and bypass valve 18 also include castellated portions 62 so that a user can easily rotate the valves in use. The connection head 14 includes apertures 68 through which the isolation valve 16 and bypass valve 18 are situated. As can be shown in FIG. 6, the head 14 includes a separate inlet manifold 72 which is secured inside the head 14 using self-tapping screws though the plurality of apertures 78 which are retained in raised projections 66. FIG. 5 also clearly shows the pressure locking ribs 58 and 60 that are used to retain the canister 32 and the filter insert 28, respectively.

FIGS. 5 and 6 show how the inlet 42 and outlet channels 48 are formed inside the connection head 14, and how the flow rates can be are controlled by the isolation valve 16 and bypass valve 18. In particular, the feed tube 38 connects to the inlet channel 42 via connection 70.

FIGS. 7 to 9 show how two successive stages or steps of filtration can be achieved by having a second filtration medium 36 contained within the canister 32 which is dimensioned to fit inside the filter insert 28. There may optionally be three or more filtration media or steps.

FIG. 7 also shows that at the bottom of the filter insert 28 there are situated a plurality of detents 86 and indents 88 which meet with corresponding indents and detents at the bottom of the housing 12. In this way, when it is desired to replace the insert 28, a user simply has to rotate the upper part of the insert 28 which exposes more of the upper part of the insert 28 above the housing 12. The insert 28 can then be slidably removed from the housing 12. As shown in FIGS. 7 and 8, to improve the structural strength of the filter insert 28 and the canister 32 they are provided with collars 84 and 54, respectively.

FIG. 14 shows an alternative approach whereby instead of a situating a plurality of detents 86 and indents 88 on the bottom of the filter housing 28, the filter housing has an elongate lifting tab or profiled section 106 which meets with a corresponding ramped on the bottom of the inside of the housing 12 (not shown). Again, the user simply rotates the upper part of the insert 28 to expose it above the housing 12 to assist removal thereof.

FIGS. 10 and 11 show detail of the spreader 40 which is connected to the end of the feed tube 38. As can be seen, the spreader 40 is generally circular in shape and includes around its periphery an outer seal portion 90 which forms an interference fit inside the insert 28. Water exiting the feed tube 38 firstly passes through a series of apertures 94 in the spreader 40 before entering the bottom of the filter medium 30 through opposing slats 92a and 92b. The slats are provided in a series of generally 90° opposing configurations such that this provides the necessary turbulence and dispersion of water through the filtration medium 30. The gaps between of the slats 92a and 92b are smaller than the physical size of the filtration medium 30. The size of the gaps between the slats 92a and 92b is also less that the diameter of the apertures 94, so that the space defined between the slats 92a and 92b and the apertures 94 does not become clogged with filtered-out impurities which would otherwise compromise the operation of the filter 10. The features of the gaps, slats and apertures described herein are of course merely optional and other arrangements are possible.

FIG. 12 shows how the present invention can be implemented with the bypass valve 18 open or partly open. The bypass valve 18 does not simply provide an open or closed arrangement but by rotating the valve 18 through 90° a certain percentage of water to be filtered can bypass the first filtration stage of filtration medium 30 and instead be selectively passed through the second filtration of the canister 32 only. This is useful when, for example, when the first filter 10 is being used in a soft water area, but is still desired to de-chlorinate the water.

The significant advantage of the invention set out in the present application is that the product can be fully recycled which prevents scrapping of large volumes of plastics material. When replacing the insert 28 it is possible to change the carbon block 36 and regenerate the filtration resin 30 contained in the insert 28. In this way it is possible to regenerate and reuse much of the filter 10 which makes huge environmental and carbon footprint benefits.

Various alterations and modifications may be made to the present invention without departing from the scope of the invention. For example, although particular embodiments refer to implementing the present invention with a two stage filtration system, this is in no way intended to be limiting as, in use, the present invention can be incorporated as a multi-stage filter depending on the size and chemistry of the impurities that need to be removed from the fluid or water supply.

1. A filter insert for filtering a fluid, comprising:
an elongate closed-ended tube including a circumferential sealing rim; and
a conduit for conveying fluid, one end of the conduit forming an inlet opening, the other end of the conduit being suitable for dispersing fluid into a filter medium located within the tube.

2. A filter insert for filtering a fluid, comprising:
an elongate closed-ended tube including a circumferential sealing rim; and
a conduit for conveying fluid, one end of the conduit forming an inlet opening, the other end of the conduit including dispersing means for dispersing fluid into a filter medium located within the tube.

3. The filter insert as claimed in claim 1, further comprising at least one filter chamber containing a second filter medium, the at least one filter chamber being interposed between the filter medium contained within the tube and an outlet opening for removal of the filtered fluid.

4. The filter insert as claimed in claim 1, wherein the conduit is formed as a cylindrical tube positioned coaxially within the tube.

5. The filter insert as claimed in claim 1, wherein the outlet opening is formed coaxially with the inlet opening.

6. The filter insert as claimed in claim 1, wherein the tube is at least partially manufactured from a flexible plastics material.

7. The filter insert as claimed in claim 1, wherein the plastics material is formed from blow-moulded high-density polyethylene or polyethylene terephthalate.

8. The filter insert as claimed in claim 1, wherein the wall thickness of the tube is up to 2.5 mm.

9. The filter insert as claimed in claim 1, wherein the filter medium is selected from the group consisting, but not limited to, any one of the following: resins, resin beads, scrims, reticulated sheets, porous membranes and ion exchange material.

10. The filter insert as claimed in claim 1, wherein said second filter medium comprises an activated carbon block.

11. The filter insert as claimed in claim 10, wherein the activated carbon block is retained within a non-woven mesh.

12. The filter insert as claimed in claim 1, wherein the at least one filter chamber is dimensioned to fit inside the tube.

13. The filter insert as claimed in claim 12, wherein the at least one filter chamber is positioned coaxially within the tube.

14. The filter insert as claimed in claim 12, wherein the at least one filter chamber includes an external circumferential screw thread adapted to engage with a corresponding internal screw thread defined inside the opening of the filter insert.

15. The filter insert as claimed in claim 1 wherein the external assembly is rigid.

16. The filter insert as claimed in claim 15 wherein the external assembly is at least partially manufactured from die cast aluminium or injection moulded plastics material.

17. The filter insert as claimed in claim 1 wherein the at least one filter chamber is at least partially manufactured from die cast aluminium or injection moulded plastics material.

18. The filter insert as claimed in claim 1, wherein the at least one filter chamber includes a radially inward flowpath.

19. The filter insert as claimed in claim 1, wherein the at least one filter chamber includes a plurality of slats or apertures.

20. The filter insert as claimed in claim 1, wherein the dispersing means comprises a spreader which is generally circular in shape and includes around its periphery an outer seal portion which forms an interference fit inside the tube.

21. The filter insert as claimed in claim 20, wherein the spreader comprises:
a generally planar body portion having a first face in communication with the filter medium located within the tube and a second face having a plurality of apertures extending therethrough;
an opening extending through the body portion from the first face to the second face for receiving the conduit; and
a plurality of slats extending through the first face.

22. The filter insert as claimed in claim 21, wherein the plurality of slats extending through the first face of the spreader are diametrically opposed.

23. The filter insert as claimed in claim 1, wherein the fluid is water; and the filter medium located within the tube filters de-calcifies the water and the second filter medium de-chlorinates the de-calcified water.

24. The filter insert as claimed in claim 1, where there is a bypass valve to control the extent to which flow occurs through different filter media.

25. A filter comprising a connector, a housing and a filter insert for filtering a fluid, comprising:
an elongate closed-ended tube including a circumferential sealing rim; and
a conduit for conveying fluid, one end of the conduit forming an inlet opening, the other end of the conduit being suitable for dispersing fluid into a filter medium located within the tube, the insert being removably receivable in the housing; the connector comprising a manifold having inlet and outlet apertures for connection to the inlet and outlet openings, respectively; the filter insert forming a fluid impermeable barrier being arranged to prevent fluid from coming into contact with the housing.

26. The filter as claimed in claim 25, wherein the connector and housing are at least partially manufactured from die cast aluminium or injection moulded plastics material.

27. The filter as claimed in claim 25, wherein the inlet and outlet apertures extend radially outward on opposing sides of the connector.

28. The filter as claimed in claim 25, further comprising an isolation valve associated with the inlet aperture and a flow bypass valve associated with the outlet aperture.

29. The filter as claimed in claim 28, wherein the isolation valve and the flow bypass valve extend axially outward from the upper surface of the connector.

30. The filter as claimed in claim 28, wherein flow bypass valve selectively recirculates fluid around the second filter medium.

31. The filter as claimed in claim 25, further comprising a clip for releasably securing the housing to a surface.

32. The filter as claimed in claim 31, wherein the clip is generally planar or L-shaped having an aperture for receiving the housing and a plurality of apertures for securing the clip to a surface.

33. The filter as claimed in claim 25, wherein the filter insert is sealingly interposed between the connector and the housing via the circumferential sealing rim.

34. The filter as claimed in claim 25, wherein the direction of fluid flow from the inlet aperture to the outlet aperture is upwardly from the base of the spreader and though the filter medium and optionally sequentially through the second filter medium and optionally further filter media.

35. The filter as claimed in claim 25, wherein the closed-ended section of the tube comprises a plurality of peripheral detents and indents which meet with corresponding peripheral indents and detents on the inside of the housing, the filter insert being removable by firstly rotating the filter insert inside said housing.

36. The filter as claimed in claim 25, wherein the closed-ended section of the tube comprises an elongate raised tab which meets with a corresponding ramped section on the inside of the housing, the filter insert being removable by firstly rotating the filter insert inside said housing.

37. A spreader for dispersing fluid into a filter medium located in a fluid impermeable filter insert, comprising:
a generally planar body portion with a first face having a plurality of slats extending therethrough and a second face having a plurality of apertures extending therethrough;
an opening extending through the body portion from the first face to the second face for receiving the fluid supply; and
a deformable outer seal portion located around its periphery which is dimensioned to form an interference fit inside the filter insert.

38. The spreader as claimed in claim 37, wherein the plurality of slats extending through the first face are diametrically opposed.

39-41. (canceled)
